(19) United States
(12) Patent Application Publication
(10) Pub. No.: US 2003/0028555 A1
(43) Pub. Date: Feb. 6, 2003

(54) Database migration

(76) Inventors: William J. Young, Golden, CO (US); Janice L. Platt, Littleton, CO (US)

Correspondence Address: HOGAN & HARTSON LLP, ONE TABOR CENTER, SUITE 1500, 1200 SEVENTEEN ST., DENVER, CO, 80202, US

(21) Appl. No.: 09/922,032

(22) Filed: Jul. 31, 2001

(51) Int. Cl. G06F 12/00

(52) U.S. Cl. 707/204

(57) ABSTRACT

The present invention provides a method for database migration. It migrates a database in one single bulk migration without the loss of any data. It can accomplish bulk migration because it uses a wrapper script, which is a single instruction given at the command line, that automates, in succession, all the scripts required for the migration. Because the present invention migrates the entire database in one bulk, it uses very little system downtime. This is unlike prior art database migration schemes which may use not only a lot of system downtime, but requires the presence of a user during the entire migration. Because the present invention can be customized to work on various database models including production database models, it is an ideal database migration process, which various DBAs can use without the need to either alter their database, or change the procedure for the migration.

### BACKGROUND OF THE INVENTION

1. Field of the Invention

This invention relates to the field of computer software, and in particular to a method for database migration.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all rights whatsoever.

2 . Background Art

The use of computers to conduct daily business has increased in popularity as much as the use of computers to conduct personal or school work. Several reasons contribute to the increase in popularity, including the way a computer stores data, the speed at which this data is accessed, edited, printed or saved, and the networking of computers.

Data on any computer is stored in an organized manner. The way a computer stores data is analogous to a filing cabinet. The cabinet itself is analogous to the data storage component of the computer commonly known as the hard-drive. A contemporary hard-drive comes in the order of several gigabytes of memory. Just like a filing cabinet is filled with folders, which in turn are filled with papers, the hard-drive is filled with directories, which in turn store data.

Each folder in a filing cabinet has a name label and date, name, number, or some such universal format. In the same way a directory has a name and contains files usually saved by date, name, size, or some such universal formatting system. Just like the names given to the folders in a filing cabinet pertain to the papers within, so do the names given to the files in a directory.

A file has a default extension name which identifies, for example, the kind of file and the program needed to open it. The opening of a file is analogous to opening a locked cabinet drawer. Just as only the right key will open the cabinet drawer, only the right program will open a file for viewing, editing, printing or saving. Thus files with default “.doc” extensions can be opened by word processing programs, or files with default “.ppt” extensions can be opened by presentation programs. Though in the world of computers, these “.doc” or “.ppt” files can be opened by more than one program, there maybe a loss of format, and sometimes loss of data too.

The speed at which a computer accesses, edits, prints or saves data stored on its hard-drives is very fast. Not only can the computer access, edit, print, or save data on a single file, but can perform several such tasks at the same time. This is commonly known as multi-tasking. These high speeds and multi-tasking capabilities can be primarily achieved due to large memory size and fast processors, both common features in contemporary computers.

Up until a few years, the directories and files on a single computer were sufficient to conduct daily business, personal or school work. Now, many directories and files are shared by several computers in a network. This means that several users not only access, but edit, print and save the same files. For a business it can be more efficient if all its computers are networked together. This means housing all files in one centralized location commonly known as a file server or database. These files can then be accessed by most computers in the network based on certain rules. If a computer is editing a certain file, then other computers cannot access the same file until the edits are saved, and the file returned to the file server. Some networking protocols allow other computers to access the same file being edited by another computer, but in a “read only” format. This kind of inter-office networking, even though it increases productivity, is still too limiting because the file server houses local information only. Most businesses rely on and use outside resources to be competitive and successful. The need for a global database is eminent and is evidenced by the birth of the Internet and its most common instantiation, the World Wide Web.

With the Internet, people can not only access data from a computer across the room, but from a computer across the globe. Data on the Internet can be edited and saved by the owners of the data, while the rest can access and use the data for personal or business use. The Internet is analogous to a computer, where the files are “web pages”. These web pages are grouped under several categories much the same way files are grouped and saved in directories on a computer. These categories have an extension name, which is analogous, for example, to the extension of files on a computer. Some of the popular extensions are “.com”, “.net”, “.org”, “.edu”, and “.gov”. The ability to access these “directories” and “files” on the Internet depends on the speed of connection of the computer. These connection speeds range from several kilobytes per second to several megabytes per second.

Just like the computer, the Internet is organized. By keeping statistical information on each user, as well as on similar products and services, the Internet maybe organized much like the filing cabinet. This statistical information is kept in several ways. Some web servers keep statistical information, while others keep logs from which statistical information is may be gathered, while still others provide scripts attached to web pages that gather statistical information. This statistical information may include user information, user password, number of visits by user, user preferences (if any), and other such personal information. This statistical information may be stored at a centralized location much the same way as the file server of an inter-office network.

Data Model

Just like filing cabinets are made out of various materials and come in various sizes, databases follow a variety of time tested and universally excepted models called data models. These data models are guidelines that cover pertinent aspects of a given problem. Some of these data models include urban planning, financial, engineering, and business. It must be noted here that a data model for a urban planning project, for example, may be very different from a data model for another urban planning project.

In this system each web page can have not only its own database which collects personal information about each user, but also share a database with other web pages. The reason for sharing a database is beneficial because many web pages share similar information which can be retrieved from the same source. Search engines like yahoo.com, hotbot.com, altavista.com, etc., are examples of web pages that may share the same database. Oracle and SQL are two of the popular databases used for this purpose that help web pages stay organized.

There are software data modeling tools, for example, ER/Studio by Embarcadaro, which may be used to model a database. These tools offers, for example, features to transfer or migrate data to customize a database model. Even though these kinds of data modeling tools work well for most database administrators (DBAs), they may not be suitable for most production database models for several reasons. Firstly, production database models require bulk migration not offered by these data modeling tools. These modeling tools are menu driven and hence require the user to choose and click the migration options offered by the tool one at a time, which may exact on computer resources and require large amounts of system time due to the windowing systems around the application. Secondly, the differences in data models, certain business rules, environment limitations, the need to provide uninterrupted customer access, and other such reasons may be responsible for customized data modeling tools. Because of these reasons, many DBA teams use their own customized tools for data migration from one database to their production model, which is disadvantageous.

### SUMMARY OF THE INVENTION

The present invention provides a method for production databases to extensively change a data model in one bulk migration while guaranteeing the retention of current data with a minimum of system downtime. The present invention is a generalized solution that can be tested by various DBA teams on their production databases with guaranteed success. The present invention solves the automation of migrating a database so production system DBAs can run scripts. In one embodiment of the present invention, a detailed verification of data correctness is solved by multiple means. In another embodiment of the present invention, a database can be successfully migrated on multiple systems. In yet another embodiment of the present invention, a general pattern can be followed that will work for many migration situations.

One or more embodiments of the present invention comprise the steps of identifying the differences between a old and new database models, abstractly representing the data with the help of views (views are a meaningful compilation of the data in a database which could be in the form of tables, indices, numerical values, or other symbols), writing scripts, which include writing functions to correct data format (for example, long character strings and special characters) conversion, building temporary tables to map old values to new, extracting data from the old database by way of insert statements to the new database (these scripts are loaded in a test area where the sample database is tested), and testing the new database.

In one embodiment of the present invention, the testing phase of the invention includes exporting the sample database, importing it in the test area, running the scripts on the sample database, and comparing the new data with the old data based on record counts, key and other value counts, graphical user interface (GUI), and logs. In one embodiment of the present invention, once the results of the above steps are analyzed, and if the scripts have run successfully based on the logs, wrapper scripts are written. These wrapper scripts automate the scripts written above, drop the old data, install new tables, and fill them with the new migrated data. If the scripts do not run successfully, then the scripts are re-written and the sample database is re-tested. Finally, once the wrapper scripts are written, instructions for running these wrapper scripts are given to the DBAs. The wrapper scripts ensure a guaranteed bulk migration of the database without the loss of data or the extensive use of system time.

### BRIEF DESCRIPTION OF THE DRAWINGS

These and other features, aspects and advantages of the present invention will become better understood with regards to the following description, appended claims, and accompanying drawings where:

FIG. 1 is a flowchart which shows the migration of a database according to an embodiment of the present invention.

FIG. 2 is a flowchart which shows the comparison between the data models of the new and old database before the migration, according to an embodiment of the present invention.

FIG. 3 is a flowchart which shows a method to identify the differences in the data model by defining views, according to an embodiment of the present invention.

FIG. 4 is a flowchart which shows the step of writing scripts after the views are defined according to an embodiment of the present invention.

FIG. 5 is a flowchart which shows the steps involved in writing the scripts according to an embodiment of the present invention.

FIG. 6 is a flowchart which shows the creation of a testing area according to an embodiment of the present invention.

FIG. 7 is a flowchart which shows the testing area being broken up into various stages according to an embodiment of the present invention.

FIG. 8 is a flowchart which shows the analysis of the result of running the scripts according to an embodiment of the present invention.

FIG. 9 is a flowchart which shows the creation of the wrapper script according to an embodiment of the present invention.

FIG. 10 is an illustration of an embodiment of a computer execution environment.

### DETAILED DESCRIPTION OF THE INVENTION

The present invention is a method for database migration. In the following description, numerous specific details are set forth to provide a more thorough description of the embodiments of the invention. It will be apparent, however, to one skilled in the art, that the invention may be practiced without specific details. In other instances, well known features have not been described in detail so as not to obstruct the invention.

In one embodiment of the invention, the migration of an old database to a new database is accomplished by issuing just one command line instruction at a system prompt. This means that a user, such as a DBA, can migrate the entire database with a single computer instruction. The present invention does this migration using a minimum of system downtime. Even though it reduces prior art system downtime, the present invention does the entire migration without the loss of data with the help of a wrapper script.

Wrapper Script

A wrapper script is a collection of individual scripts. The user, such as a DBA, by executing this one wrapper script at a command prompt executes in succession all the individual scripts that make up the wrapper script. By having the user issue just one computer instruction at a command prompt, it allows for the migration of the entire database without the user having to be present for the entire duration of the migration. This in turn cuts down on man-hours, as well as system downtime.

The wrapper script is the last in a series of operations before the instructions for the migration of a database are handed over to the DBA. The other operations include identifying data model differences by defining views, writing individual scripts to take care of individual aspects of the migration, creating a test area to run and test these individual scripts, and analyzing the results of running and testing these individual scripts. Some of these operations like writing the individual scripts, creating a testing area, and comparing the old data with new data are further broken up into several steps. All operations and their sub-steps are discussed in further detail below.

The present invention is a database migration process which various DBAs can use on their production databases without having to alter either their database or the procedure for the migration. Unlike prior art processes, which are not standardized to migrate all kinds of databases, the current invention can be customized to work on a variety of databases.

Database Migration

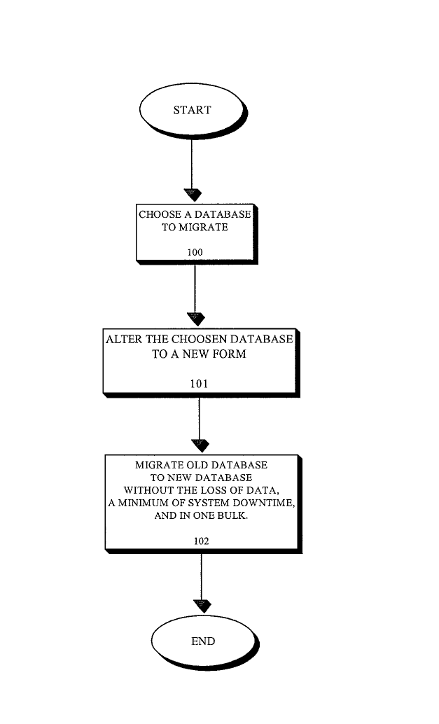

FIG. 1 is a flowchart showing the migration of a database according to an embodiment of the present invention. At step 100, a database is chosen to be migrated. At step 101, the database is altered to a new form. At step 102 the altered database is migrated. Altering the database to a new form is accomplished without the loss of any data, with a minimum of system downtime, and using one command line instruction.

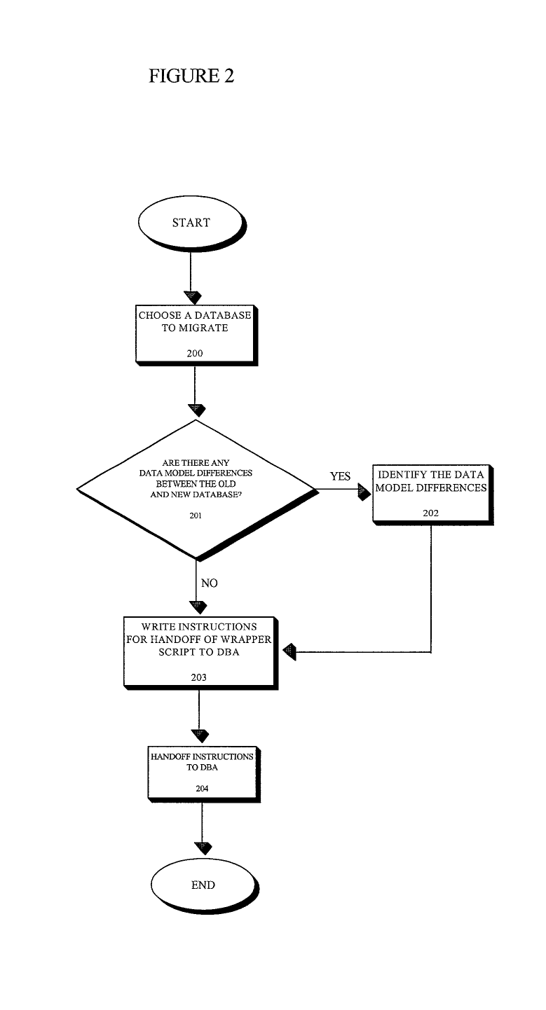

FIG. 2 is a flowchart which shows the comparison between the data models of a new and old database before the migration according to an embodiment of the present invention. Comparison of data models is essential because it gives any differences in field names and sizes, any differences in the key values, any differences in the indexing, any differences in the tables or their structure, etc. The results of this comparison will eventually affect the views and data links further down in the migration process. At step 200 a database is chosen for migration. Next, at step 201, any data model differences between the old and new database are checked. If there are differences, then at step 202 they are identified, else at step 203 instructions for the handoff of the wrapper script are written. Finally, at step 204, these instructions are handed off to a DBA.

Views

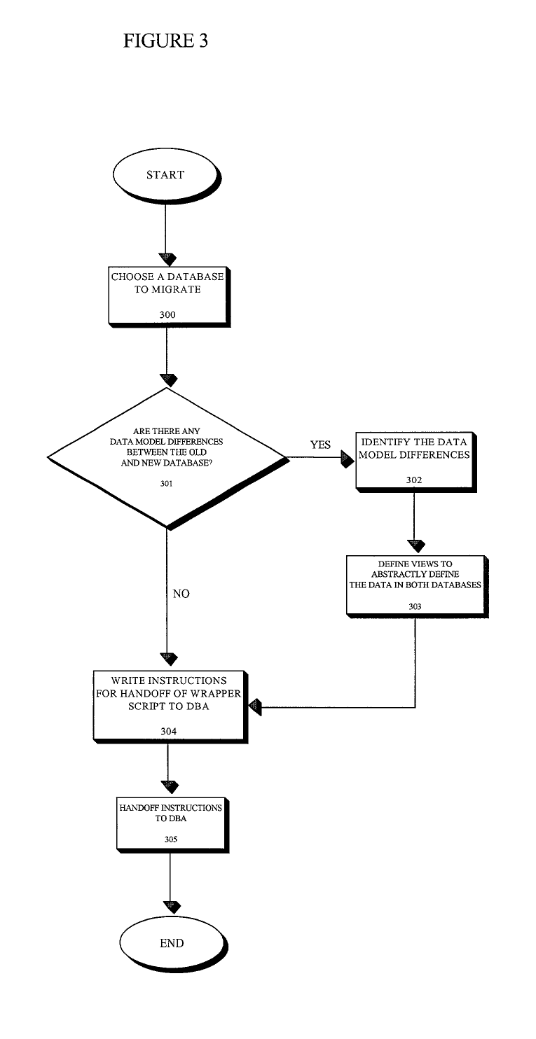

FIG. 3 is a flowchart which shows a method to identify the differences in a data model according to an embodiment of the present invention. At step 300 a database is chosen for migration. Next, at step 301, any differences between the old and new data models are checked. If any differences are found, then at step 302 they are identified, and at step 303 views are defined to abstractly look at these differences. Views are a meaningful compilation of the data in a database, which can be easily read and understood by a human. For example, an employee database may have tables containing personal information like home address and family information, along with salary information including deduction amounts, and vacation pay. A view is a way to combine all these different tables containing different data types like text and numbers into one table-like collection which can be read and understood easily. Next, at step 304, instructions are written for the handoff of the wrapper script to a DBA, and at step 305 the handoff is completed.

Scripts

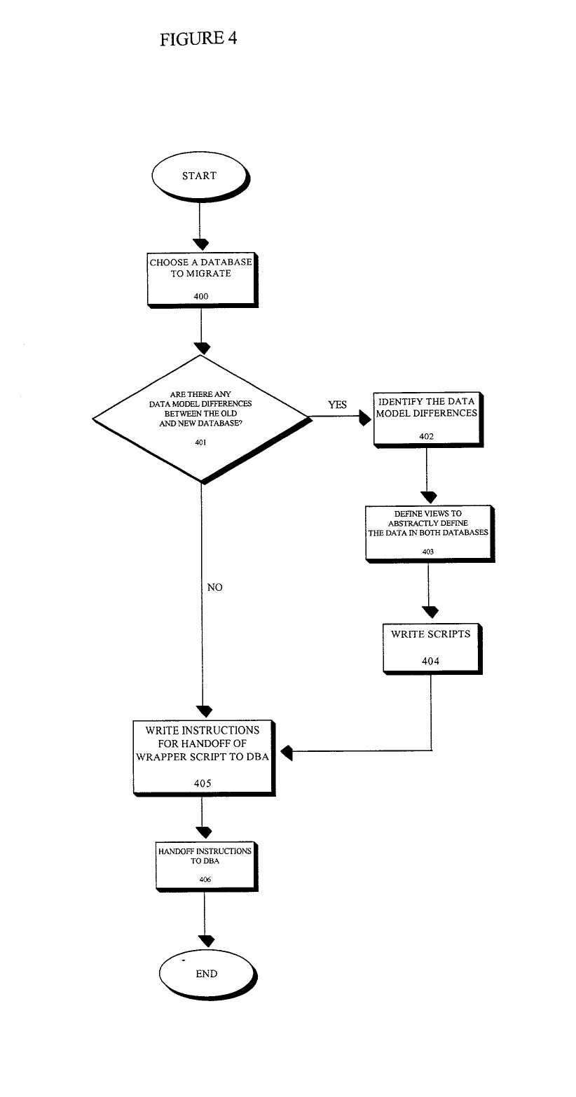

FIG. 4 is a flowchart which shows the step after the views are defined according to an embodiment of the present invention. At step 400, a database is chosen for migration. Next, at step 401, any differences between the old and new data models are checked. If any differences are found, they are identified at step 402. After which, at step 403, views are defined, and scripts are written at step 404 to take care of these differences. A script is a computer instruction, usually typed at a command prompt, which will migrate an aspect of the database. Unlike prior art where the user has to aim and click a graphical driven menu to accomplish an aspect of the migration before the next one can be accomplished, the present invention does the migration of the entire database by running these individual scripts underneath the blanket of a main program. Next, at step 405, instructions for the handoff of the wrapper script are written for a DBA, and at step 406 the handoff is completed.

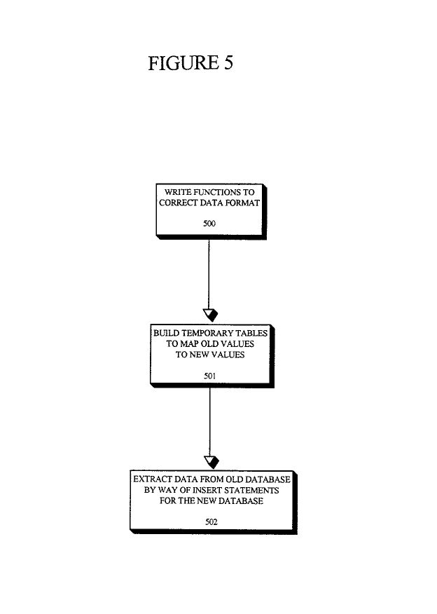

FIG. 5 is a flowchart which shows the steps involved in writing the scripts according to an embodiment of the present invention. At step 500, functions to correct data format (for example, long strings and special characters) conversions are written. Next, at step 501, temporary tables are built to map old values to new values. Finally, at step 502, the old data is extracted by way of insert statements from the old database into the new database. The steps as well as the order that make up the script writing stage can vary depending upon the data model, as well as the types of database involved.

Testing

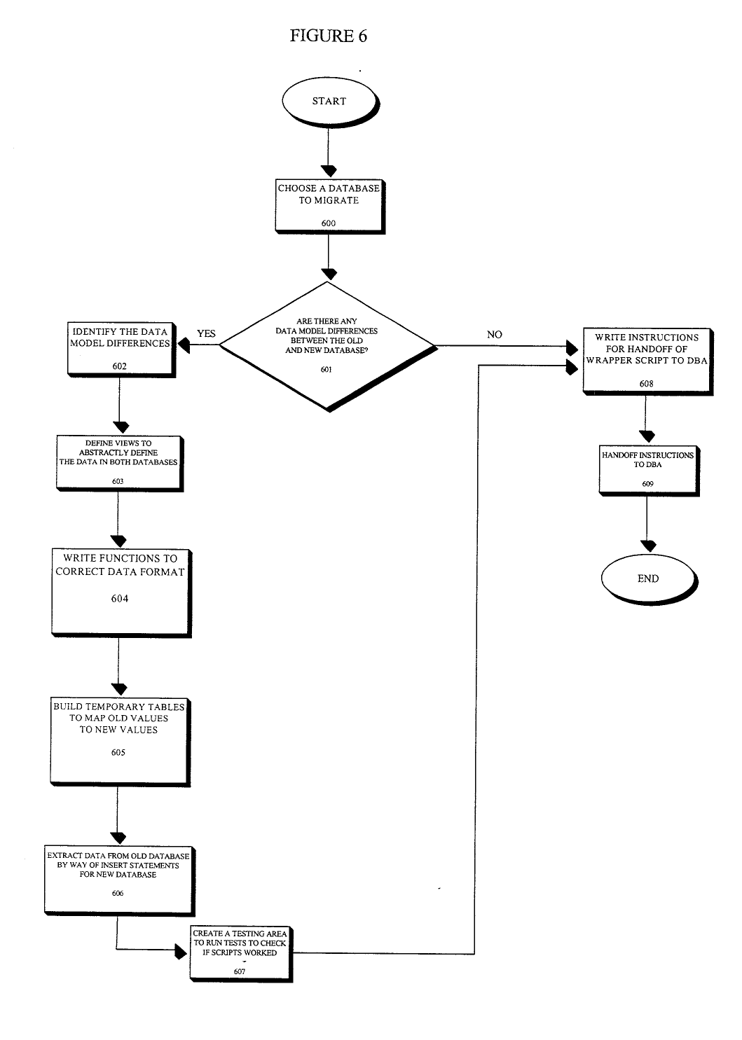

FIG. 6 is a flowchart which shows the creation of a test area according to an embodiment of the present invention. At step 600, a database is chosen for migration. Next, at step 601, any differences between the old and new data model are checked. If any differences are found, then at step 602 they are identified. At step 603, views are defined after which the scripts mentioned at step 404 in FIG. 4 (further broken up into 3 steps)are executed, and include: writing functions to correct data format at step 604 (same as step 500 in FIG. 5), building temporary tables to map old and new values at step 605 (same as step 501 in FIG. 5), and extracting data from the old database by way of insert statements for the new database at step 606 (same as step 502 in FIG. 5). A test area is created at step 607 where a copy of the sample or old database is bought in for the transfer. The testing is always performed on a copy of the sample database which is brought into the test area, while the original or first generation copy is left intact at the origin. The test area is usually also the place where the scripts along with their intended results are housed. Instructions for using the wrapper script are written at step 608, and the handoff to a DBA is completed at step 609. If at step 601 there are no data model differences between the old and new databases, then steps 608 and 609 are performed.

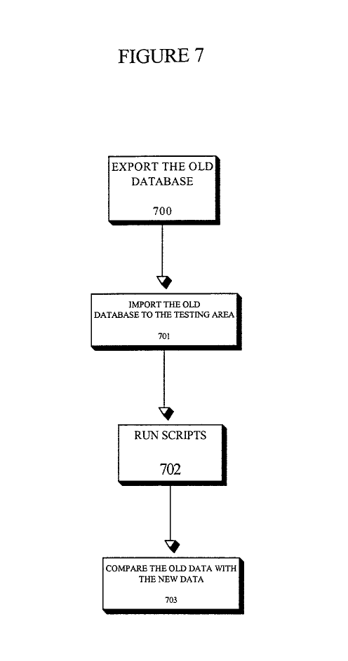

FIG. 7 is a flowchart which shows the stages involved in creating a test area according to an embodiment of the present invention. At step 700, a copy of the old or sample database is exported. At step 701, this copy is imported into the test area, and at step 702 the scripts created at steps 500-502 in FIG. 5 (or conversely steps 604-606 in FIG. 6) are run on it. Finally at step 703, the old and new databases are compared and differences noted.

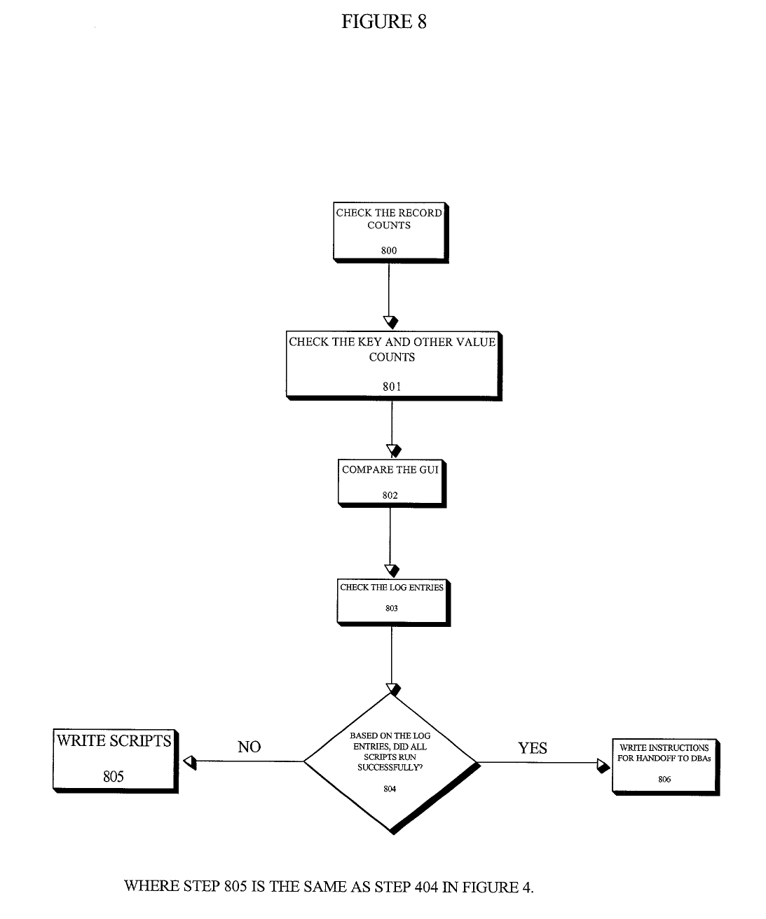

FIG. 8 is a flowchart which shows comparison step 703 of FIG. 7 between the two databases further broken down into various steps. At step 800, the record counts are checked automatically. Record counts keep a track of every aspect of the migration process. If, for example, a one-to-one mapping is desired between the old and new database, the record counts for each aspect of the migration should not be more than one, while on the other hand if a one-to-many mapping is desired, then the record counts should be greater than one. At step 801, the key and other value counts are checked. At step 802, GUI comparison between the old and new database is performed. This step is also performed automatically, and helps in the general layout and format of the new database. Next, at step 803, the log entries are checked. This step helps to point out any aspects of the migration not accomplished by the scripts. Next, at step 804, the results of running the scripts created at steps 500-502 in FIG. 5 are checked with the desired results. If the results are inconclusive, incomplete, or different from the ones expected, then step 805 is performed, which is the same as steps 500-502 in FIG. 5, else we go to step 806 where instructions for the handoff of the wrapper script is written for a DBA.

Analysis and Writing of Wragpper Script

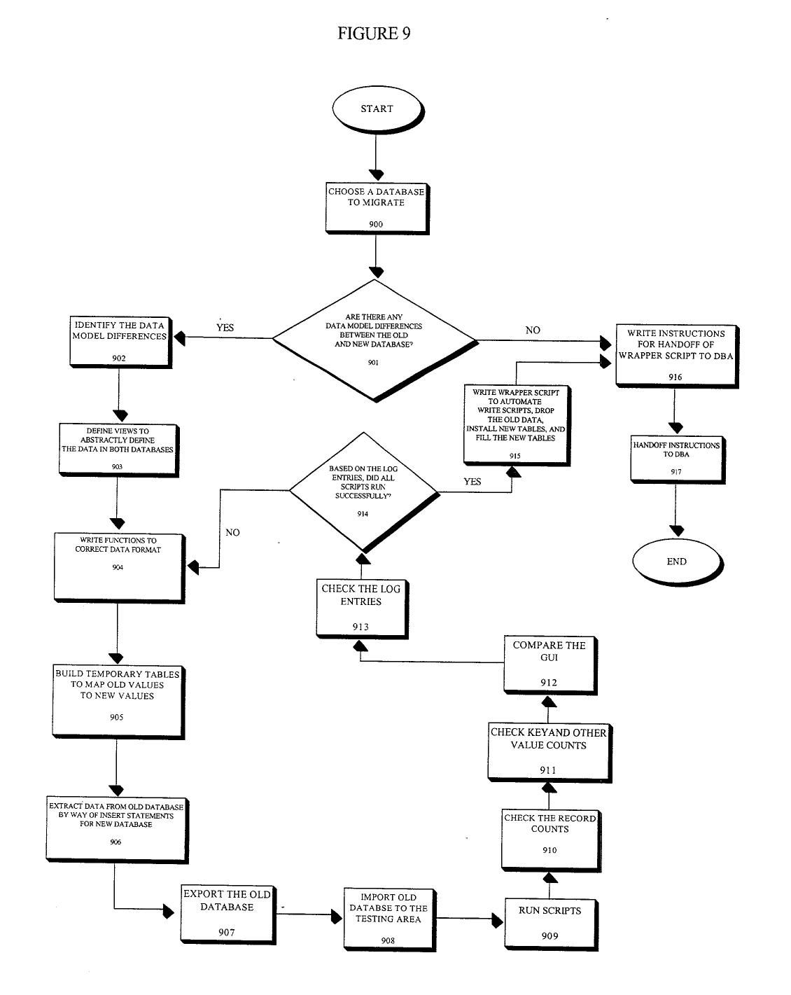

FIG. 9 is a flowchart which shows the invention including writing of the wrapper script according to an embodiment of the present invention. At step 900, a database is chosen for migration. Next, at step 901, any differences between the old and new databases are checked. If any differences are found, then at step 902 they are identified and views are defined at step 903. After that the scripts mentioned at step 404 in FIG. 4 are written. These scripts are further broken down, as seen earlier, into the following steps: writing functions to correct data format (for example, long strings and special characters) at step 904, building temporary tables to map old and new values at step 905, and extracting data from the old database by way of insert statements for the new database at step 906. Next, a test area is created where a copy of the old (or sample) database is brought in so that the scripts created above can be run on it. The creation of this test area is accomplished via the following steps: at step 907, a copy of the old database is exported; at step 908, this copy is imported into the test area; and finally, at step 909 the scripts created at steps 904-906 above are run on the copy. The results of running these scripts are compared with the expected results, and are accomplished in the following steps, where checking the record counts is done at step 910, checking key and other value counts is done at step 911, comparing the GUI is done at step 912, and checking the log entries is done at step 913. Based on the log entries, the results of a successful script run are checked at step 914. If the results are incorrect or inconclusive then the process returns to step 904 where the scripts are written again and the closed loop involving steps 904-914 are run again. This closed loop is repeated until all scripts run successfully at step 914. If all scripts run successfully, then a single wrapper script is written at step 915, which runs all the scripts (and more if needed) written at steps 904-906 above. This wrapper script, as explained earlier, is a single instruction given at the command line which in turn runs successively all the scripts needed for a successful transfer. Instructions on how to use this wrapper script are written at step 916 and handed off to a DBA at step 917. If at step 901, there are no data model differences between the old and new database, then steps 916 and 917 are performed.

Embodiment of a Computer Execution Environment

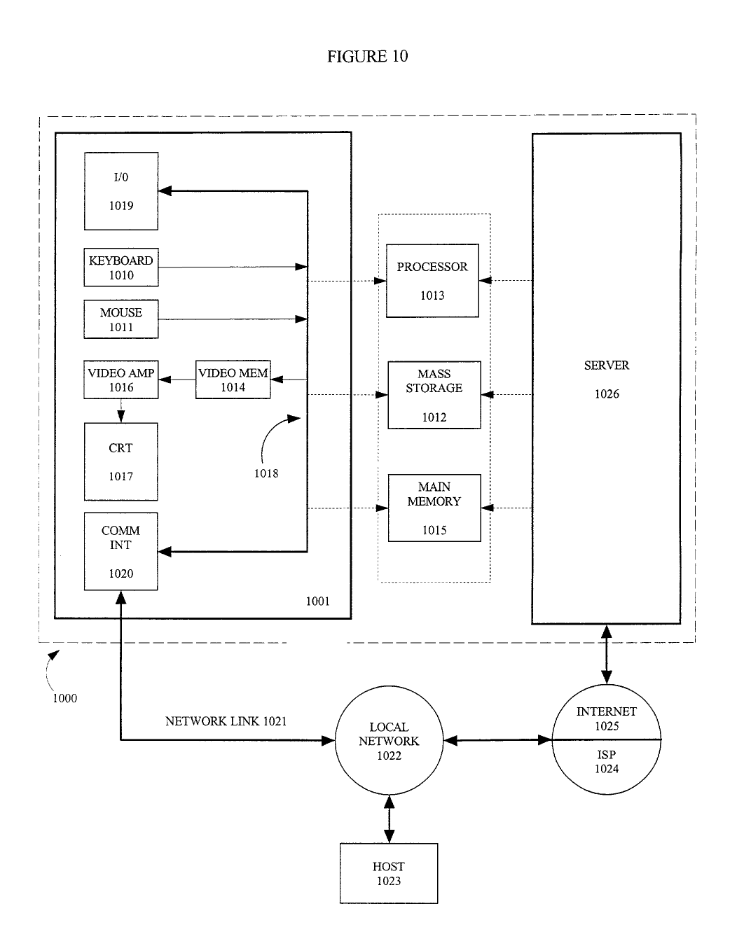

An embodiment of the invention can be implemented as computer software in the form of computer readable code executed in a desktop general purpose computing environment such as environment 1000 illustrated in FIG. 10, or in the form of bytecode class files running in such an environment. A keyboard 1010 and mouse 1011 are coupled to a bi-directional system bus 1018. The keyboard and mouse are for introducing user input to a computer 1001 and communicating that user input to processor 1013.

Computer 1001 may also include a communication interface 1020 coupled to bus 1018. Communication interface 1020 provides a two-way data communication coupling via a network link 1021 to a local network 1022. For example, if communication interface 1020 is an integrated services digital network (ISDN) card or a modem, communication interface 1020 provides a data communication connection to the corresponding type of telephone line, which comprises part of network link 1021. If communication interface 1020 is a local area network (LAN) card, communication interface 1020 provides a data communication connection via network link 1021 to a compatible LAN. Wireless links are also possible. In any such implementation, communication interface 1020 sends and receives electrical, electromagnetic or optical signals, which carry digital data streams representing various types of information.

Network link 1021 typically provides data communication through one or more networks to other data devices. For example, network link 1021 may provide a connection through local network 1022 to local server computer 1023 or to data equipment operated by ISP 1024. ISP 1024 in turn provides data communication services through the world wide packet data communication network now commonly referred to as the “Internet” 1025. Local network 1022 and Internet 1025 both use electrical, electromagnetic or optical signals, which carry digital data streams. The signals through the various networks and the signals on network link 1021 and through communication interface 1020, which carry the digital data to and from computer 1000, are exemplary forms of carrier waves transporting the information.

Processor 1013 may reside wholly on client computer 1001 or wholly on server 1026 or processor 1013 may have its computational power distributed between computer 1001 and server 1026. In the case where processor 1013 resides wholly on server 1026, the results of the computations performed by processor 1013 are transmitted to computer 1001 via Internet 1025, Internet Service Provider (ISP) 1024, local network 1022 and communication interface 1020. In this way, computer 1001 is able to display the results of the computation to a user in the form of output. Other suitable input devices may be used in addition to, or in place of, the mouse 1011 and keyboard 1010. I/O (input/output) unit 1019 coupled to bidirectional system bus 1018 represents such I/O elements as a printer, A/V (audio/video) I/O, etc.

Computer 1001 includes a video memory 1014, main memory 1015 and mass storage 1012, all coupled to bidirectional system bus 1018 along with keyboard 1010, mouse 1011 and processor 1013.

As with processor 1013, in various computing environments, main memory 1015 and mass storage 1012, can reside wholly on server 1026 or computer 1001, or they may be distributed between the two. Examples of systems where processor 1013, main memory 1015, and mass storage 1012 are distributed between computer 1001 and server 1026 include the thin-client computing architecture developed by Sun Microsystems, Inc., the palm pilot computing device, Internet ready cellular phones, and other Internet computing devices.

The mass storage 1012 may include both fixed and removable media, such as magnetic, optical or magnetic optical storage systems or any other available mass storage technology. Bus 1018 may contain, for example, thirty-two address lines for addressing video memory 1014 or main memory 1015. The system bus 1018 also includes, for example, a 32-bit data bus for transferring data between and among the components, such as processor 1013, main memory 1015, video memory 1014, and mass storage 1012. Alternatively, multiplex data/address lines may be used instead of separate data and address lines.

In one embodiment of the invention, the processor 1013 is a microprocessor manufactured by Motorola, such as the 680×0 processor or a microprocessor manufactured by Intel, such as the 80×86 or Pentium processor, or a SPARC microprocessor from Sun Microsystems, Inc. However, any other suitable microprocessor or microcomputer may be utilized. Main memory 1015 is comprised of dynamic random access memory (DRAM).

Video memory 1014 is a dual-ported video random access memory. One port of the video memory 1014 is coupled to video amplifier 1016. The video amplifier 1016 is used to drive the cathode ray tube (CRT) raster monitor 1017. Video amplifier 1016 is well known in the art and may be implemented by any suitable apparatus. This circuitry converts pixel data stored in video memory 1014 to a raster signal suitable for use by monitor 1017. Monitor 1017 is a type of monitor suitable for displaying graphic images.

Computer 1001 can send messages and receive data, including program code, through the network(s), network link 1021, and communication interface 1020. In the Internet example, remote server computer 1026 might transmit a requested code for an application program through Internet 1025, ISP 1024, local network 1022 and communication interface 1020. The received code may be executed by processor 1013 as it is received, and/or stored in mass storage 1012, or other non-volatile storage for later execution. In this manner, computer 1000 may obtain application code in the form of a carrier wave. Alternatively, remote server computer 1026 may execute applications using processor 1013, and utilize mass storage 1012, and/or video memory 1015. The results of the execution at server 1026 are then transmitted through Internet 1025, ISP 1024, local network 1022, and communication interface 1020. In this example, computer 1001 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

Hence, a method for database migration without the loss of any data is tackled by the present invention. This migration is not only done in one bulk, but it does so using a minimum of system downtime. The present invention is a database migration tool which DBAs of various databases can use without having to alter their databases or the procedure for the migration. Unlike prior art, the current invention can be customized to work on a variety of databases.

We claim:

1. A method for migrating a database comprising:
obtaining said database in a first format;
representing said database in an abstract format;
using said abstract format to convert said database to a second format; and
migrating said database in said second format.

2. The method of claim 1 wherein said database is a production database.

3. The method of claim 1 wherein said database uses a data model.

4. The method of claim 1 wherein said abstract format comprises of one or more views.

5. The method of claim 1 wherein said step of using said abstract format further comprises:
writing scripts.

6. The method of claim 5 wherein step of writing said scripts further comprises:
writing functions to correct data format conversion.

7. The method of claim 5 wherein step of writing said scripts further comprises:
building temporary tables to map values in the first format database to values in the second format database.

8. The method of claim 5 wherein step of writing said scripts further comprises:
extracting data from database in first format into insert statements for the database in the second format.

9. The method of claim 8 wherein said step of extracting data from database in first format into insert statements for the database in the second format further comprises:
exporting a sample database;
importing the said sample database into a test area;
running said scripts created in claim 5; and
comparing the data of the database in a first format with the data of the database in a second format.

10. The method of claim 9 wherein step of comparing said data of the database in a first format with said data of the database in a second format further comprises:
comparing and checking the record counts;
comparing and checking the key and other value counts;
comparing and checking the graphical user interface (GUI); and
comparing and checking the logs.

11. A computer program product comprising:
a computer usable medium having computer readable program code embodied therein configured to migrate a database, said computer product comprising:
computer readable code configured to cause a computer to obtain said database in a first format;
computer readable code configured to cause a computer to represent said database in an abstract format;
computer readable code configured to cause a computer to use said abstract format to convert database to a second format; and
computer readable code configured to cause a computer to migrate said database in said second format.

12. The computer program product of claim 11 wherein said database is a production database.

13. The computer program product of claim 11 wherein said database uses a data model.

14. The computer program product of claim 11 wherein said abstract format comprises of one or more views.

15. The computer program product of claim 14 wherein said step to use said abstract format further comprises:
to write scripts.

16. The computer program product of claim 15 wherein step to write said scripts further comprises:
to write functions to correct data format conversion.

17. The computer program product of claim 15 wherein step to write said scripts further comprises:
to build temporary tables to map values in the first format database to values in the second format database.

18. The computer program product of claim 15 wherein step to write said scripts further comprises:
to extract data from database in first format into insert statements for the database in the second format.

19. The computer program product of claim 18 wherein step to extract data from database in first format into insert statements for the database in the second format farther comprises:
to export a sample database;
to import the said sample database into a test area;
to run said scripts created in claim 15; and
to compare the data of the database in a first format with the data of the database in a second format.

20. The computer program product of claim 19 wherein step to compare said data of the database in a first format with said data of the database in a second format further comprises:
to compare and check the record counts;
to compare and check the key and other value counts;
to compare and check the GUI; and
to compare and check the logs.
